(19) United States
(12) Patent Application Publication
(10) Pub. No.: US 2026/0092767 A1
(43) Pub. Date: Apr. 2, 2026

(54) WEIGHING DEVICE

(71) Applicant: SEIKO EPSON CORPORATION, TOKYO (JP)

(72) Inventor: Koji CHINDO, Suwa-shi (JP)

(21) Appl. No.: 19/341,588

(22) Filed: Sep. 26, 2025

(30) Foreign Application Priority Data
Sep. 27, 2024 (JP) 2024-168305

(51) Int. Cl. G01B 9/02015; G01G 3/12; G01G 21/23

(52) U.S. Cl. CPC G01B 9/02029; G01G 3/125; G01G 21/23

(57) ABSTRACT

A weighing device includes: a support having a placement surface on which an object to be measured is to be placed, the placement surface being displaced according to a mass of the object to be measured; a mirror disposed on the support; a laser interferometer configured to detect, using a laser beam, a change in optical path length to the mirror due to the displacement of the placement surface; and a controller configured to calculate a weight or a mass of the object to be measured based on the detected change in optical path length, in which the laser interferometer includes a laser light source configured to emit the laser beam, and a optical modulator including a vibrator and configured to modulate a frequency of the laser beam using a vibration of the vibrator.

The present application is based on, and claims priority from JP Application Serial Number 2024-168305, filed September 27, 2024, the disclosure of which is hereby incorporated by reference herein in its entirety.

### BACKGROUND

### 1. Technical Field

The present disclosure relates to a weighing device.

### 2. Related Art

JP-A-07-151590 discloses a precision scale including a short-stroke measurement mechanism, a load receiver, a hanger that couples the load receiver to the measurement mechanism, a leaf spring as a receiver, and a fixing portion that couples a central portion of the leaf spring to a bottom portion of the hanger. Such a precision scale can be protected against a load applied in an unintended direction, and the precision scale can therefore weigh an object to be measured with high accuracy.

JP-A-07-151590 is an example of the related art.

In the precision scale disclosed in JP-A-07-151590, the use of the short-stroke measurement mechanism makes it easy to achieve miniaturization, but there is a problem of insufficient improvement in measurement accuracy. Therefore, there is a demand for implementing a weighing device capable of measuring a weight or a mass of an object to be measured with high accuracy while achieving miniaturization.

### SUMMARY

A weighing device according to an application example of the present disclosure includes: a support having a placement surface on which an object to be measured is to be placed, the placement surface being displaced according to a mass of the object to be measured; a mirror disposed on the support; a laser interferometer configured to detect, using a laser beam, a change in optical path length to the mirror due to the displacement of the placement surface; and a controller configured to calculate a weight or a mass of the object to be measured based on the detected change in optical path length, in which the laser interferometer includes a laser light source configured to emit the laser beam, and a optical modulator including a vibrator and configured to modulate a frequency of the laser beam using a vibration of the vibrator.

### BRIEF DESCRIPTION OF THE DRAWINGS

FIG. 1 is a schematic diagram showing a configuration of a weighing device according to a first embodiment.

FIG. 2 is a schematic diagram showing a mirror according to a modification.

FIG. 3 is a schematic diagram showing a configuration of a weighing device according to a second embodiment.

FIG. 4 is a schematic diagram showing a configuration of a weighing device according to a third embodiment.

FIG. 5 is a schematic diagram showing an optical member according to a modification.

FIG. 6 is a schematic diagram showing a configuration of a weighing device according to a fourth embodiment.

FIG. 7 is a schematic diagram showing a mirror according to a modification.

FIG. 8 is a schematic diagram showing a configuration of a weighing device according to a fifth embodiment.

### DESCRIPTION OF EMBODIMENTS

Hereinafter, a weighing device according to the present disclosure will be described in detail based on embodiments shown in the accompanying drawings.

### 1. First Embodiment

First, a weighing device according to a first embodiment will be described.

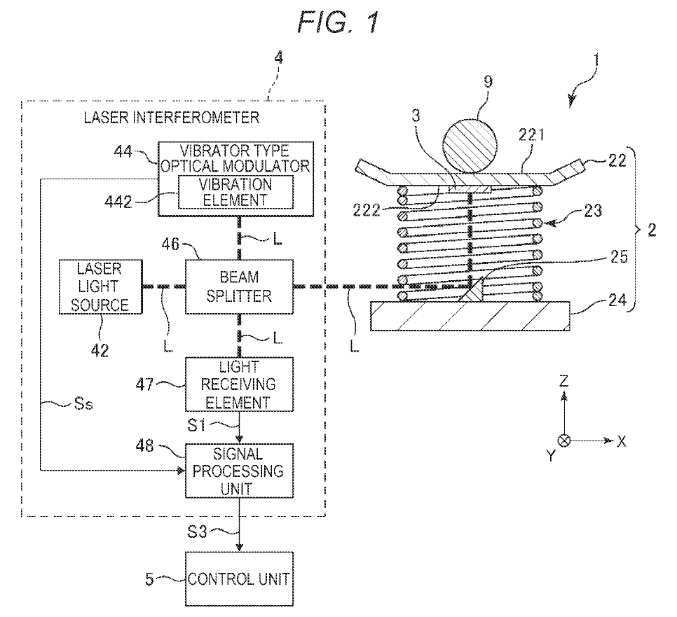

FIG. 1 is a schematic diagram showing a configuration of a weighing device 1 according to the first embodiment. Note that, in the drawings of the present application, three axes orthogonal to one another are set as an X axis, a Y axis, and a Z axis. Each axis is indicated by an arrow, and a tip side of the arrow is defined as "positive", and a base end side of the arrow is defined as "negative". In the following description, for example, an "X axis direction" includes both a positive direction and a negative direction of the X axis. The same applies to a Y axis direction and a Z axis direction. In addition, the Z axis is parallel to a vertical axis, and a Z axis plus side is also referred to as an "upper side" and a Z axis minus side is also referred to as a "lower side".

The weighing device 1 shown in FIG. 1 includes a support 2, a mirror 3, a laser interferometer 4, and a controller 5. The support 2 has a placement surface 221 on which an object to be measured 9 is to be placed, and the placement surface 221 is displaced according to a mass of the object to be measured 9. The mirror 3 is disposed on the support 2. The laser interferometer 4 includes a laser light source 42 and a optical modulator 44, and detects, using a laser interference technique using a laser beam L, a change S3 in optical path length to the mirror 3 due to the displacement of the placement surface 221. The laser light source 42 emits the laser beam L. The optical modulator 44 includes a vibrator 442 and modulates a frequency of the laser beam L using a vibration of the vibrator 442. The controller 5 calculates a weight of the object to be measured 9 based on the detected change S3 in optical path length.

The placement surface 221 is displaced according to the mass of the object to be measured 9. The laser interferometer 4 can detect a displacement amount of the placement surface 221 with high accuracy using the laser beam L. Therefore, the controller 5 can accurately calculate the weight of the object to be measured 9. In addition, the laser interferometer 4 includes the optical modulator 44, and can thus be easily miniaturized. Therefore, according to the above configuration, it is possible to implement the weighing device 1 capable of measuring the weight of the object to be measured 9 with high accuracy while achieving miniaturization. Hereinafter, each part of the weighing device 1 will be described in detail.

### 1.1. Support

The support 2 shown in FIG. 1 includes a scale pan 22 having the placement surface 221, an elastic body 23, a base 24, and an optical path conversion unit 25.

The scale pan 22 having the placement surface 221 is a tray on which the object to be measured 9 is to be placed. A bottom surface of the scale pan 22 shown in FIG. 1 is the placement surface 221 on which the object to be measured 9 is to be placed. The placement surface 221 is a surface facing upward.

The elastic body 23 is coupled to a back surface 222 located opposite to the placement surface 221 of the scale pan 22. The elastic body 23 is a member that is disposed between the scale pan 22 and the base 24 and that elastically deforms when receiving a load. The elastic body 23 shown in FIG. 1 is, for example, a coil spring. A load due to the mass of the object to be measured 9 placed on the placement surface 221 is applied to the elastic body 23. Accordingly, the elastic body 23 elastically deforms in the Z axis direction according to the mass of the object to be measured 9. That is, the elastic body 23 displaces the placement surface 221 by a displacement amount corresponding to the mass of the object to be measured 9. Therefore, the elastic body 23 only needs to be a member whose elastic deformation amount has a predetermined correlation with the weight of the object to be measured 9.

According to such a configuration, the weight or the like of the object to be measured 9 can be easily measured simply by placing the object to be measured 9 on the placement surface 221 of the scale pan 22. Accordingly, the weighing device 1 capable of easily performing a measurement operation is obtained.

In addition, by using the elastic deformation of the elastic body 23, the mass of the object to be measured 9 can be converted into the displacement amount of the placement surface 221 without consuming energy. Therefore, the weighing device 1 with low power consumption is obtained. Note that, the elastic body 23 is not limited to a coil spring, and examples thereof include a metal spring such as a leaf spring, a mechanical spring such as a rubber spring made of a rubber, an elastomer, or the like, a magnet spring using a magnetic repulsive force by a permanent magnet, an electromagnet spring using a magnetic repulsive force by an electromagnet, and an electrostatic spring using an electrostatic force.

Note that, the placement surface 221 is not limited to the surface facing upward as long as it is a surface on which the object to be measured 9 can be placed. For example, when the object to be measured 9 is placed on the support 2 so as to be hooked, the surface of a hook or the like on which the object to be measured 9 is hooked is the placement surface.

The base 24 is placed on a floor surface, an upper surface of a base, or the like, and sandwiches the elastic body 23 with the scale pan 22.

The optical path conversion unit 25 is provided on an optical path of the laser beam L and converts the optical path of the laser beam L. The optical path conversion unit 25 includes, for example, optical elements such as a reflecting mirror, a lens, and an optical fiber. As an example, a reflecting mirror is used for the optical path conversion unit 25 shown in FIG. 1. The optical path conversion unit 25 shown in FIG. 1 converts an optical path of the laser beam L incident from an X axis minus side toward an X axis plus side so as to be directed upward. In addition, an optical path of the laser beam L reflected by the mirror 3 and directed downward is converted so as to be directed to the X axis minus side. By providing such an optical path conversion unit 25, a degree of freedom in disposing the laser interferometer 4 with respect to the mirror 3 can be increased. Accordingly, it is possible to achieve the miniaturization, thinning, and weight reduction of the weighing device 1.

Note that, the optical path conversion unit 25 may be provided as necessary, and may be omitted, for example, when the laser interferometer 4 is disposed on the base 24 or when the laser interferometer 4 is disposed below the base 24. Note that, in the latter case, the laser beam L can be introduced above the base 24 through a through hole (not shown) formed in the base 24.

### 1.2. Mirror

The mirror 3 shown in FIG. 1 is disposed at a central portion of the back surface 222 located opposite to the placement surface 221 of the scale pan 22. When the object to be measured 9 is placed on the placement surface 221, the scale pan 22 is displaced downward according to the mass of the object to be measured 9. At the same time, the back surface 222 and the mirrors 3 disposed on the back surface 222 are also displaced downward by the same displacement amount as the placement surface 221. Therefore, by detecting the change S3 in optical path length from the laser interferometer 4 to the mirror 3 using the laser interferometer 4, the weight of the object to be measured 9 can be accurately measured.

The mirror 3 is not particularly limited as long as it is a member that reflects the laser beam L. The mirror 3 may be, for example, a glass mirror, a metal mirror, or a resin mirror. The mirror 3 shown in FIG. 1 has a flat reflection surface. Therefore, in the mirror 3 shown in FIG. 1, an incident angle of the laser beam L is set to approximately 90°. Accordingly, a reflection angle is also approximately 90°.

Note that, the mirror 3 is not limited to being disposed at the above position. For example, the mirror 3 may be disposed on the bottom surface or an edge portion of the scale pan 22, or may be coupled to the scale pan 22 via any coupling member (not shown).

The elastic body 23 shown in FIG. 1 is a coil spring and has a cylindrical shape as a whole. Therefore, a scale beam between the elastic body 23 and the back surface 222 has an annular shape so as to surround the mirror 3 disposed at the central portion of the back surface 222 when viewed from below. That is, the elastic body 23 is coupled to an annular portion of the back surface 222 located outside the mirror 3. According to such a configuration, when the object to be measured 9 is placed on the placement surface 221, a large change in posture of the scale pan 22 is prevented. That is, the elastic body 23 can elastically deform while a horizontal state of the placement surface 221 is favorably maintained. Accordingly, it is possible to prevent occurrence of a measurement error due to an unintended inclination of the mirror 3 and instability of the object to be measured 9 due to an unintended inclination of the placement surface 221. Note that, examples of the annular shape include an annular shape and a square annular shape.

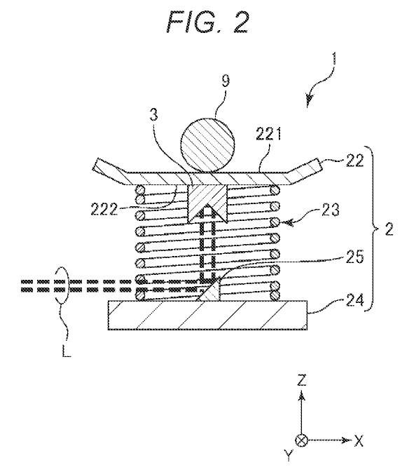

FIG. 2 is a schematic diagram showing the mirror 3 according to a modification. The weighing device 1 shown in FIG. 2 is the same as the weighing device 1 shown in FIG. 1 except that the shape of the mirror 3 is different.

The mirror 3 shown in FIG. 2 is a corner cube mirror. The corner cube mirror is a mirror having retroreflectivity. The retroreflectivity refers to a property that light incident on a mirror is reflected so as to follow an incident optical path regardless of an incident angle. By using the corner cube mirror as the mirror 3, for example, even when the scale pan 22 is inclined and the mirror 3 is inclined accordingly, most of the light incident on the mirror 3 can be returned to the optical path conversion unit 25. Accordingly, for example, even when the scale pan 22 is inclined, it is possible to prevent a decrease in detection accuracy for the change S3 in optical path length detected by the laser interferometer 4. In addition, since a tolerance of a positional deviation between the mirror 3 and the optical path conversion unit 25 is increased, it is possible to implement the weighing device 1 having high ease of assembly.

Note that, as the mirror 3, a mirror having retroreflectivity other than the corner cube mirror may be used. Examples of the mirror having retroreflectivity include a corner cube prism and a retroreflector sheet having internal reflectivity.

### 1.3. Laser Interferometer

The laser interferometer 4 shown in FIG. 1 detects, using the laser beam L, the change S3 in optical path length to the mirror 3 due to the displacement of the placement surface 221. The laser interferometer 4 shown in FIG. 1 includes the laser light source 42, the optical modulator 44, a beam splitter 46, a photodetector 47, and a processor 48. As the laser interferometer 4 including the optical modulator 44, for example, a laser interferometer disclosed in JP-A-2022-38156 is preferably used. Since such a laser interferometer 4 includes the optical modulator 44, the miniaturization, the weight reduction, low power consumption, and the like are achieved.

Examples of the laser light source 42 include a laser light source disclosed in JP-A-2022-38156. Among them, using a semiconductor laser such as a vertical cavity surface emitting laser (VCSEL) allows further miniaturization of the laser interferometer 4.

The optical modulator 44 uses the vibrator 442 to impart a modulation signal to the laser beam L. Examples of the optical modulator 44 include an optical modulator disclosed in JP-A-2022-38156. The optical modulator 44 includes the vibrator 442. Examples of the vibrator 442 include a quartz crystal unit, a silicon vibrator, and a ceramic vibrator. The quartz crystal unit may be an AT vibrator, a tuning fork type vibrator, or any other vibrator. The vibrators described above are vibrators that use a mechanical resonance phenomenon, and therefore each have a high Q value and easily allow stabilization of a natural frequency. Therefore, a signal to noise ratio (S/N ratio) of the modulation signal applied to the laser beam L using the vibration of the vibrator 442 can be easily increased. As a result, the change S3 in optical path length to the mirror 3 due to the displacement of the placement surface 221 can be accurately detected, and the weighing device 1 capable of measuring the weight of the object to be measured 9 with high accuracy can be implemented.

The optical modulator 44 also includes a vibrator oscillation circuit that generates a reference signal Ss using the vibrator 442 as a signal source (source vibration). Examples of the vibrator oscillation circuit include an inverter type oscillation circuit and a Colpitts type oscillation circuit. The oscillation circuits described above can each generate the reference signal Ss, which is highly stable in terms of frequency, by using the vibrator 442 having a high Q value for the mechanical resonance phenomenon. Accordingly, the S/N ratio of the reference signal Ss can also be increased, and the S/N ratio of various signals based on the reference signal Ss can also be increased. In addition, by using the vibrator 442 as a signal source, the power required to generate the reference signal Ss can be reduced. Therefore, the laser interferometer 4 including the optical modulator 44 also contributes to the low power consumption of the weighing device 1.

Further, the optical modulator 44 is small and light. Therefore, the laser interferometer 4 including the optical modulator 44 also contributes to the miniaturization and the weight reduction of the weighing device 1.

The beam splitter 46 splits the laser beam L emitted from the laser light source 42 into two. One of the laser beams L returns to the beam splitter 46 via the mirror 3. The other laser beam L returns to the beam splitter 46 via the optical modulator 44. Both the laser beams L are combined by the beam splitter 46 and received by the photodetector 47 as interference light.

The photodetector 47 detects an intensity (optical beat) of the interference light and outputs a light receiving signal S1 (optical beat signal). Examples of the photodetector 47 include a photodiode and a phototransistor.

The processor 48 calculates the change S3 in optical path length to the mirror 3 due to the displacement of the placement surface 221 based on the light receiving signal S1 and the reference signal Ss generated using the vibrator 442 as a signal source.

As the processor 48, for example, a preprocessor and a demodulator disclosed in JP-A-2022-38156 can be applied. The preprocessor performs preprocessing on the light receiving signal S1 based on the reference signal Ss, and the demodulator demodulates, based on the reference signal Ss, the signal that has been subjected to the preprocessing into a mirror displacement signal. The mirror displacement signal is a signal (phase change) imparted to the laser beam L due to the displacement of the mirror 3. Such a displacement detection method using the laser interferometer 4 is referred to as an optical heterodyne method. According to the optical heterodyne method, even when the phase of light cannot be directly measured, it is possible to detect a change in optical path difference by slightly differentiating frequencies of the two laser beams L to be interfered with each other and detecting an optical beat. Accordingly, the change S3 in optical path length to the mirror 3 can be detected with very high accuracy.

### 1.4. Controller

The controller 5 shown in FIG. 1 calculates the weight of the object to be measured 9 based on the change S3 in optical path length to the mirror 3 due to the displacement of the placement surface 221 detected by the laser interferometer 4.

When the elastic body 23 elastically deforms in the Z axis direction according to the mass of the object to be measured 9, the controller 5 calculates the weight of the object to be measured 9 according to the change S3 in optical path length and a spring constant of the elastic body 23. Specifically, the load due to the mass of the object to be measured 9 corresponds to a product of the spring constant of the elastic body 23 and a deformation amount of the elastic body 23 calculated based on the change S3 in optical path length. The controller 5 calculates the load due to the mass of the object to be measured 9 based on this relationship. Then, the weight of the object to be measured 9 is calculated based on the load. When a gravitational acceleration at a place where the weighing device 1 is installed is known, the mass of the object to be measured 9 is calculated based on the calculated weight.

Therefore, the controller 5 may have a function of storing the spring constant of the elastic body 23, the refractive index of the optical path of the laser beam L, the gravitational acceleration at the place where the weighing device 1 is installed, and the like, in addition to the function of performing the above calculation.

The functions of the processor 48 and the controller 5 are implemented by, for example, hardware including a CPU, a memory, and an interface. The hardware is, for example, a microcomputer. The CPU is an abbreviation for "central processing unit". Examples of the memory include any nonvolatile memory element (ROM), any volatile memory element (RAM), and a detachable external memory element. Examples of the interface include a digital input/output port such as a universal serial bus (USB). Each of the functions of the processor 48 and the controller 5 is implemented by the CPU executing a program loaded in advance in the memory. Note that, instead of or in addition to the method in which the CPU executes the program to implement the functions described above, a method in which hardware, such as a field programmable gate array (FPGA), an application specific integrated circuit (ASIC), or any other integrated circuit, or discrete parts, implements the functions described above may be used.

### 2. Second Embodiment

Next, a weighing device according to a second embodiment will be described.

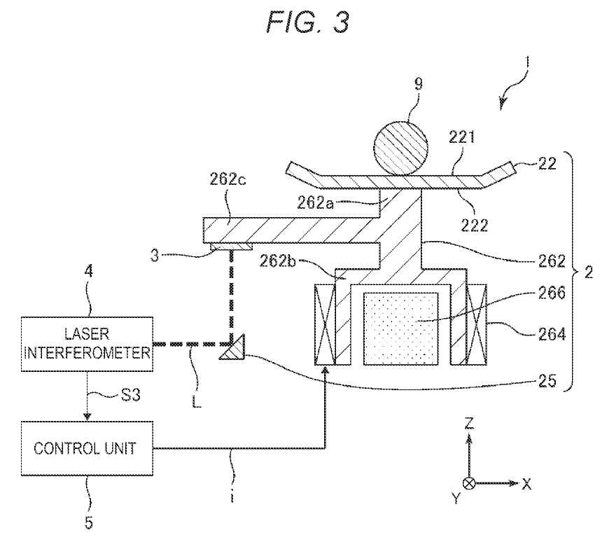

FIG. 3 is a schematic diagram showing a configuration of the weighing device 1 according to the second embodiment.

Hereinafter, the second embodiment will be described. In the following description, differences from the first embodiment will be primarily described, and substantially the same items will be omitted. Note that, in FIG. 3, elements that are substantially the same as those in the first embodiment described above have the same reference numerals.

In the weighing device 1 according to the first embodiment described above, the weight of the object to be measured 9 is calculated based on the change S3 in optical path length to the mirror 3 detected by the laser interferometer 4 and the spring constant of the elastic body 23. In contrast, the weighing device 1 according to the second embodiment uses a so-called force balance type weighing method.

The support 2 shown in FIG. 3 includes the scale pan 22 having the placement surface 221, the optical path conversion unit 25, a coupler 262, an electromagnetic coil 264, and a magnet 266.

The coupler 262 couples the scale pan 22 to the electromagnetic coil 264. Specifically, the coupler 262 includes an upper portion 262a extending downward from the back surface 222 of the scale pan 22, a lower portion 262b surrounding the magnet 266 located below the scale pan 22, and a mirror attachment portion 262c.

The mirror 3 shown in FIG. 3 is attached to the mirror attachment portion 262c. The optical path of the laser beam L emitted from the laser interferometer 4 is converted by the optical path conversion unit 25 and is incident on the mirror 3. The optical path of the laser beam L reflected by the mirror 3 is converted by the optical path conversion unit 25 and returns to the laser interferometer 4.

The electromagnetic coil 264 is fixed to an outer peripheral surface of the lower portion 262b. The electromagnetic coil 264 is electrically coupled to the controller 5. When the controller 5 causes a current i to flow through the electromagnetic coil 264, a magnetic field is generated around the electromagnetic coil 264, and an electromagnetic force is generated between the electromagnetic coil 264 and the magnet 266. The controller 5 has a function of adjusting the current i flowing through the electromagnetic coil 264 such that a load of the mass of the object to be measured 9 pushing the coupler 262 downward and the electromagnetic force of the electromagnetic coil 264 pushing the coupler 262 upward are in equilibrium (balanced). When the load and the electromagnetic force are in equilibrium, the controller 5 acquires the current i flowing through the electromagnetic coil 264. Since the current i is proportional to the electromagnetic force, the weight of the object to be measured 9 can be calculated based on the current i.

Note that, whether the load and the electromagnetic force are in equilibrium can be detected based on the change S3 in optical path length to the mirror 3 detected by the laser interferometer 4. The necessary current i can be calculated by inputting the change S3 in optical path length to the controller 5. That is, the controller 5 has a function of calculating the weight of the object to be measured 9 based on the change S3 in optical path length to the mirror 3 detected by the laser interferometer 4. Note that, in the present specification, balancing of forces (loads) is also referred to as "equilibrium".

The second embodiment described above can also provide the same effects provided by the first embodiment.

In addition, the second embodiment is also useful in that the influence of deterioration with time of the mechanical spring and the permanent magnet can be eliminated.

### 3. Third Embodiment

Next, a weighing device according to a third embodiment will be described.

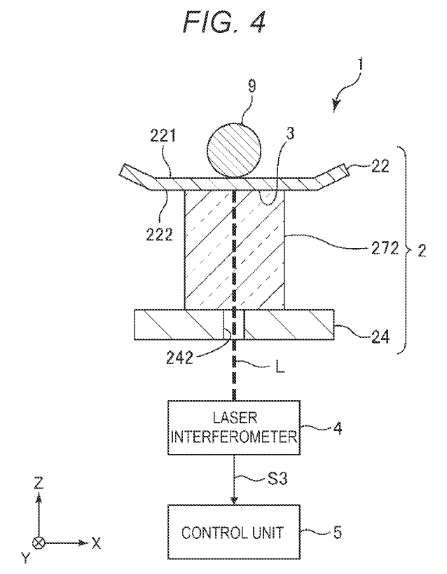

FIG. 4 is a schematic diagram showing a configuration of the weighing device 1 according to the third embodiment.

Hereinafter, the third embodiment will be described. In the following description, differences from the first embodiment will be primarily described, and substantially the same items will be omitted. Note that, in FIG. 4, elements that are substantially the same as those in the first embodiment described above have the same reference numerals.

In the weighing device 1 according to the first embodiment described above, the weight of the object to be measured 9 is calculated based on the change S3 in optical path length to the mirror 3 detected by the laser interferometer 4 and the spring constant of the elastic body 23. In contrast, the weighing device 1 according to the third embodiment calculates the weight of the object to be measured 9 based on the change S3 in optical path length due to a change in refractive index of an optical member 272 in the support 2.

The support 2 shown in FIG. 4 includes the scale pan 22 having the placement surface 221, the base 24, and the optical member 272.

The optical member 272 is coupled to the back surface 222 of the scale pan 22. The optical member 272 is a member that is disposed between the scale pan 22 and the base 24 and whose refractive index changes when receiving a load due to the mass of the object to be measured 9. As an example, the optical member 272 shown in FIG. 4 is a member that has a block shape, has a transmitting property to the laser beam L, and is disposed on the optical path of the laser beam L. A through hole 242 penetrating in the Z axis direction is formed in the base 24 shown in FIG. 4. The laser beam L emitted from the laser interferometer 4 is incident on the optical member 272 via the through hole 242.

The mirror 3 shown in FIG. 4 is disposed on the optical member 272. Specifically, the mirror 3 shown in FIG. 4 is formed by an interface between the optical member 272 and the back surface 222 of the scale pan 22. In such a mirror 3, since light reflectivity of the back surface 222 can be used, a good reflectance can be ensured.

The laser beam L incident on the optical member 272 propagates inside the optical member 272, is reflected by the mirror 3, propagates inside the optical member 272 again, and returns to the laser interferometer 4.

The laser interferometer 4 shown in FIG. 4 detects, using the laser beam L, the change S3 in optical path length to the mirror 3 due to the displacement of the placement surface 221. There is in a relationship where the refractive index of the optical member 272 increases when the load due to the mass of the object to be measured 9 increases, as the optical member 272 is compressed. When the refractive index of the optical member 272 increases, the optical path length (optical distance) of the laser beam L propagating through the optical member 272 also increases. That is, the optical path length from the laser interferometer 4 to the mirror 3 increases.

The controller 5 shown in FIG. 4 stores the relationship between the magnitude of the load received by the optical member 272 and the change S3 in optical path length to the mirror 3. The controller 5 has a function of calculating the magnitude of the load and calculating the weight of the object to be measured 9 based on the relationship and the change S3 in optical path length to the mirror 3.

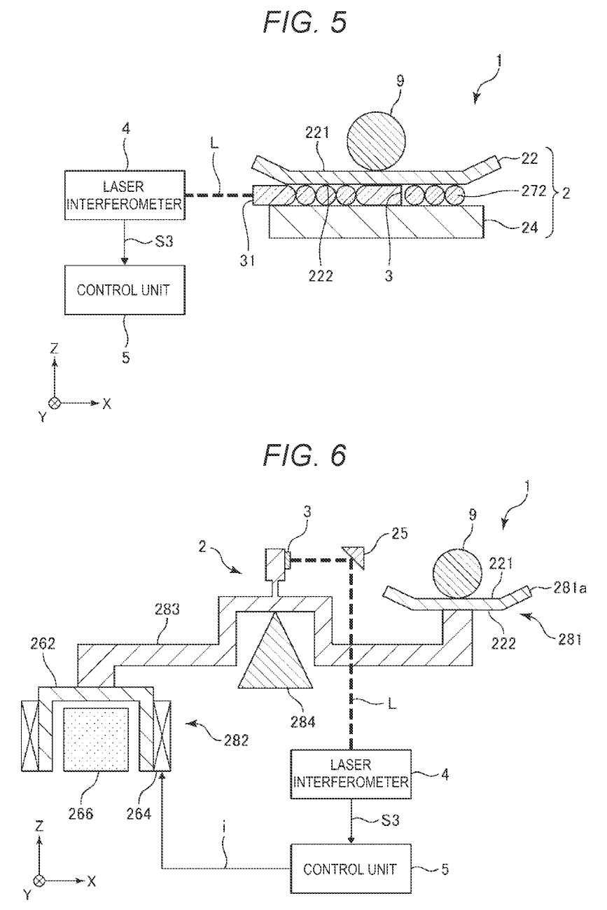

FIG. 5 is a schematic diagram showing the optical member 272 according to a modification.

The optical member 272 shown in FIG. 5 is an optical fiber wound in a spiral shape along an upper surface of the base 24. The mirror 3 shown in FIG. 5 is a terminal end surface of the optical fiber. The laser beam L emitted from the laser interferometer 4 is incident from an incidence/emission end surface 31 of the optical fiber and propagates spirally along a longitudinal direction of the optical fiber. Then, the light is reflected by the mirror 3, propagates through the optical fiber again, and returns to the laser interferometer 4. Therefore, the optical member 272 shown in FIG. 5 can ensure a long optical path length even in a space-saving manner. Accordingly, it is possible to increase a rate of change in optical path length when the optical member 272 receives a load. As a result, calculation accuracy for the weight of the object to be measured 9 can be improved.

The mirror 3 shown in FIG. 5 is the terminal end surface of the optical fiber. The terminal end surface may be provided with light reflectivity by forming a metal thin film, and it is preferable to impart the light reflectivity at an interface between the optical fiber and outside air. Such a mirror 3 has a simple structure and thus contributes to cost reduction of the weighing device 1.

The optical fiber used as the optical member 272 shown in FIG. 5 may be a glass optical fiber or a resin optical fiber. However, in view of a large rate of change in refractive index when a load is applied, a resin optical fiber is preferably used.

The third embodiment described above can also provide the same effects provided by the first embodiment.

The third embodiment is also useful in that the influence of wind, convection, static electricity, magnetization of components, and the like can be eliminated.

### 4. Fourth Embodiment

Next, a weighing device according to a fourth embodiment will be described.

FIG. 6 is a schematic diagram showing a configuration of the weighing device 1 according to the fourth embodiment.

Hereinafter, the fourth embodiment will be described. In the following description, differences from the first embodiment will be primarily described, and substantially the same items will be omitted. Note that, in FIG. 6, elements that are substantially the same as those in the first embodiment described above have the same reference numerals.

The weighing device 1 according to the first embodiment described above uses the principle of spring scale. In contrast, the weighing device 1 according to the fourth embodiment uses the principle of only a balance.

The support 2 shown in FIG. 6 includes a first scale 281, a second scale 282, a scale beam 283, and a fulcrum 284.

The first scale 281 includes a scale pan 281a having the placement surface 221. The scale pan 281a having the placement surface 221 is a tray on which the object to be measured 9 is to be placed. A bottom surface of the scale pan 281a shown in FIG. 6 is the placement surface 221 on which the object to be measured 9 is to be placed.

The second scale 282 is a portion in which a compensation mass for the object to be measured 9 is set. Examples of a method of setting the compensation mass in the second scale 282 include a method of using an electromagnetic force, a method of using an electrostatic force, a method of using a mass change due to charging and discharging of a capacitor, a secondary battery, or the like, a method of using a light radiation pressure, and a method of placing a weight or the like on a tray, and one or a combination of two or more thereof is used.

Among them, the method using an electromagnetic force is implemented using an electromagnetic coil, a magnet, or the like as described above. In addition, the method using an electrostatic force is implemented using, for example, an electrostatic actuator.

The weighing device 1 according to the embodiment uses a so-called force balance type weighing method. Therefore, the compensation mass to be set in the second scale 282 is set such that a load due to the compensation mass is in equilibrium with the load due to the mass of the object to be measured 9 placed on the first scale 281. In FIG. 6, as an example, the coupler 262, the electromagnetic coil 264, and the magnet 266 similar to those in FIG. 3 are provided. In this case, the weight of the object to be measured 9 is calculated based on the compensation mass (electromagnetic force) during the equilibrium.

Note that, whether the load due to the mass of the object to be measured 9 and the load due to the compensation mass are in equilibrium can be detected based on the change S3 in optical path length to the mirror 3 detected by the laser interferometer 4. The compensation mass required for equilibrium can be calculated by inputting the change S3 in optical path length to the controller 5. Then, the weight of the object to be measured 9 can be calculated based on the compensation mass during the equilibrium. That is, the controller 5 shown in FIG. 6 has a function of calculating the weight of the object to be measured 9 based on the change S3 in optical path length to the mirror 3 detected by the laser interferometer 4.

Note that, a weighing method other than the force balance type method may be used. For example, when evaluating whether the mass of the object to be measured 9 is greater than a reference mass or less than the reference mass, the change S3 in optical path length to the mirror 3 detected by the laser interferometer 4 may be used to evaluate the mass of the object to be measured 9.

The scale beam 283 is a member that couples the first scale 281 to the second scale 282. As an example, the scale beam 283 shown in FIG. 6 extends in the horizontal direction, supports the first scale 281 from below, and supports the second scale 282 from above.

The fulcrum 284 supports a central portion of the scale beam 283 from below. Accordingly, the support 2 functions as a balance that can check the balance between a moment of gravity acting on the first scale 281 and a moment of the electromagnetic force acting on the second scale 282. That is, the scale beam 283 swings with the Y axis as a swing axis, and stops when the two moments are balanced with each other.

The mirror 3 shown in FIG. 6 is disposed on the support 2. Specifically, the scale beam 283 is formed so as to protrude toward a side (upper side) opposite to the fulcrum 284 shown in FIG. 6, and the mirror 3 is disposed at this portion. As an example, the mirror 3 has a reflection surface facing the X axis plus side. The optical path of the laser beam L emitted from the laser interferometer 4 is converted by the optical path conversion unit 25 and is incident on the mirror 3. The optical path of the laser beam L reflected by the mirror 3 is converted by the optical path conversion unit 25 and returns to the laser interferometer 4. Note that, the optical path conversion unit 25 may be provided as necessary, and may be omitted depending on the disposition of the laser interferometer 4.

The reflection surface of the mirror 3 faces in a direction (X axis plus side) different from a displacement direction of the placement surface 221. Then, the mirror 3 swings about the Y axis as a swing axis according to a balanced state of the scale beam 283. Therefore, the optical path of the laser beam L incident on the mirror 3 swings according to a swing angle, but since a swing width is sufficiently small, the weight of the object to be measured 9 can be determined based on the change S3 in optical path length to the mirror 3.

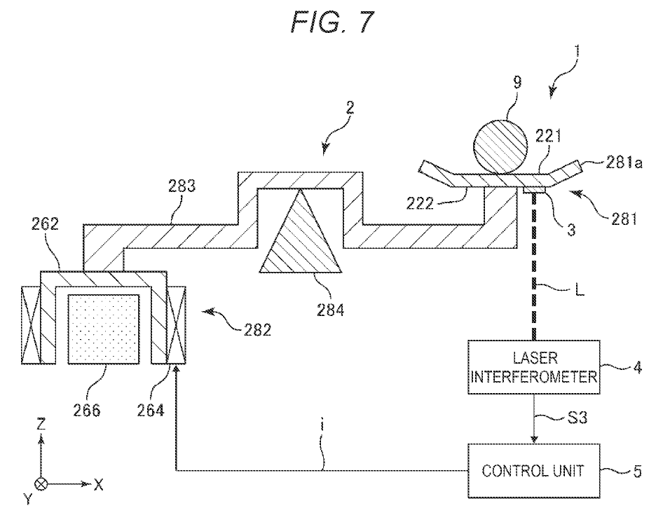

FIG. 7 is a schematic diagram showing the mirror 3 according to a modification. The weighing device 1 shown in FIG. 7 is the same as the weighing device 1 shown in FIG. 6 except that the disposition of the mirror 3 is different.

The mirror 3 shown in FIG. 7 is disposed on the back surface 222 of the scale pan 281a of the first scale 281. Since the first scale 281 has a large distance from the fulcrum 284 in the support 2, the displacement amount when the object to be measured 9 is placed on the placement surface 221 is large. Therefore, by disposing the mirror 3 on the back surface 222 of the scale pan 281a, the rate of change in optical path length when the object to be measured 9 is placed on the placement surface 221 can be increased. As a result, the calculation accuracy for the weight of the object to be measured 9 can be improved.

Note that, depending on rigidity of the scale beam 283 and the weight of the object to be measured 9, the scale beam 283 may be deflected. In this case, the change S3 in optical path length detected by the laser interferometer 4 is influenced. Therefore, the controller 5 may have a function of eliminating the influence of the deflection. For example, when the compensation mass during the equilibrium is 1 mg, the scale beam 283 is deflected such that the placement surface 221 is displaced downward by 10 nm. In this case, it is sufficient that a weight corresponding to the deflection amount of 10 nm is subtracted from the weight of the object to be measured 9 calculated based on the change S3 in optical path length. Therefore, the controller 5 may have a function of holding a relationship between the compensation mass and the deflection amount of the scale beam 283 as a table or a function.

The controller 5 shown in FIGS. 6 and 7 has a function of adjusting the compensation mass such that the load of the mass of the object to be measured 9 pushing the first scale 281 downward and the load of the compensation mass set in the second scale 282 pushing the second scale 282 downward are in equilibrium. Since the compensation mass when both loads are in equilibrium is equal to the mass of the object to be measured 9, the weight of the object to be measured 9 is determined.

Note that, whether both loads are in equilibrium is determined based on the change S3 in optical path length to the mirror 3 (a change in optical path length to the mirror 3 due to the displacement of the placement surface 221) detected by the laser interferometer 4. A necessary compensation mass can be calculated by inputting the change S3 in optical path length to the controller 5.

The fourth embodiment described above can also provide the same effects provided by the first embodiment.

Note that, in both FIGS. 6 and 7, a mirror having retroreflectivity may be used as the mirror 3. Accordingly, even when a posture of the mirror 3 changes, most of the laser beam L can be returned to the laser interferometer 4.

### 5. Fifth Embodiment

Next, a weighing device according to a fifth embodiment will be described.

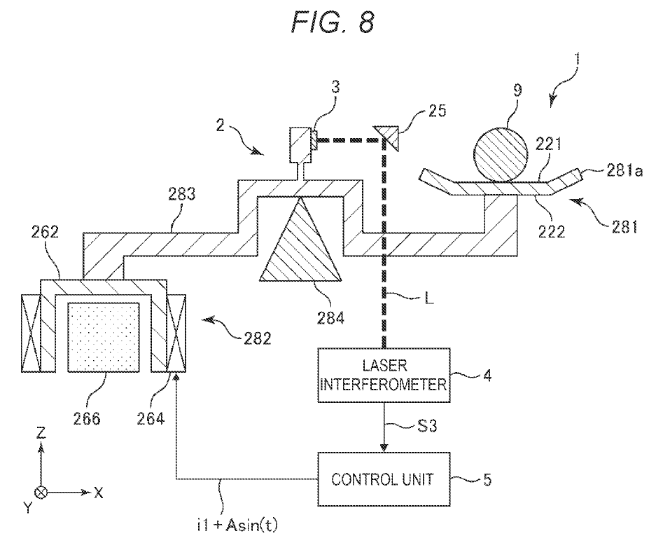

FIG. 8 is a schematic diagram showing a configuration of the weighing device 1 according to the fifth embodiment.

Hereinafter, the fifth embodiment will be described. In the following description, differences from the fourth embodiment will be primarily described, and substantially the same items will be omitted. Note that, in FIG. 8, elements that are substantially the same as those in the fourth embodiment described above have the same reference numerals.

The fifth embodiment is the same as the fourth embodiment except that the compensation mass set in the second scale 282 is temporally changed, the change S3 in optical path length to the mirror 3 is detected by the laser interferometer 4, and the controller 5 calculates the mass of the object to be measured 9 based on the detection result of the change S3 in optical path length.

In the weighing device 1 according to the fifth embodiment, the object to be measured 9 is placed on the placement surface 221, the compensation mass is set to be in an equilibrium state, and then the compensation mass is temporally changed at a constant amplitude. For example, when the method of setting the compensation mass is a method using an electromagnetic force, the compensation mass is swung by temporally changing a current flowing through an electromagnetic coil. The temporal change of the current at this time is set such that the optical path length swings at a constant amplitude. The laser interferometer 4 detects the change S3 in optical path length to the mirror 3 due to the displacement of the placement surface 221. In FIG. 8, as an example, the mirror 3 is disposed on the scale beam 283, but the disposition of the mirror 3 is not limited thereto as long as the mirror 3 is disposed at a position on the support 2 where the displacement of the placement surface 221 can be detected. Then, the controller 5 calculates the mass of the object to be measured 9 based on an amplitude of the change S3 in optical path length. A specific example of the procedure is as follows.

First, the object to be measured 9 is placed on the placement surface 221, and the compensation mass is set such that the support 2, which is a balance, is in equilibrium. The current flowing through the electromagnetic coil during the equilibrium is defined as i1. Next, the current flowing through the electromagnetic coil is changed at a constant amplitude A around the current i1. Then, the support 2, which is a balance, also swings at a constant amplitude. At this time, the current flowing through the electromagnetic coil is represented by i1+Asin(t), where t is a time. Next, an amplitude B of the change S3 in optical path length to the mirror 3 is detected by the laser interferometer 4. There is a correlation between the detected amplitude B of the change S3 in optical path length and the mass of the object to be measured 9. Specifically, when the mass of the object to be measured 9 is small, the amplitude B of the change S3 in optical path length increases, and when the mass of the object to be measured 9 is large, the amplitude B of the change S3 in optical path length decreases. Therefore, the controller 5 calculates the mass of the object to be measured 9 based on the amplitude B of the change S3 in optical path length and the correlation determined in advance.

Conversely, the amplitude of the temporal change of the compensation mass may be set such that the optical path length detected by the laser interferometer 4 changes at a constant amplitude regardless of the mass of the object to be measured 9. For example, when the method of setting the compensation mass is a method using an electromagnetic force, the amplitude A of the current i1+Asin(t) is adjusted such that the amplitude B of the change S3 in optical path length detected by the laser interferometer 4 is constant. Then, the controller 5 calculates the mass of the object to be measured 9 based on the amplitude A of the current i1+Asin(t) (the amplitude of the temporal change of the compensation mass). A specific example of the procedure is as follows.

First, the object to be measured 9 is placed on the placement surface 221, and the compensation mass is set such that the support 2, which is a balance, is in equilibrium. The current flowing through the electromagnetic coil during the equilibrium is defined as i1. Next, the current flowing through the electromagnetic coil is changed at a suitable amplitude around the current i1. Then, the support 2, which is a balance, also swings. At this time, the current flowing through the electromagnetic coil is represented by i1+Asin(t), where t is a time. Next, the amplitude B of the change S3 in optical path length to the mirror 3 is detected by the laser interferometer 4. Next, the amplitude A of the current i1+Asin(t) is adjusted such that the detected amplitude B of the change S3 in optical path length is constant. There is a correlation between the amplitude A of the current i1+Asin(t) and the mass of the object to be measured 9. Specifically, when the mass of the object to be measured 9 is small, the amplitude A of the current i1+Asin(t) is small, and when the mass of the object to be measured 9 is large, the amplitude A of the current i1+Asin(t) needs to be large. Therefore, the controller 5 calculates the mass of the object to be measured 9 based on the amplitude A and the correlation determined in advance.

According to the fifth embodiment, the mass of the object to be measured 9 can be directly measured regardless of the gravitational acceleration at the place where the weighing device 1 is installed. Therefore, the fifth embodiment is useful in that the mass of the object to be measured 9 can be measured more accurately without being influenced by the gravitational acceleration.

Besides, in the fifth embodiment described above, the same effects provided by the fourth embodiment are obtained.

### 6. Modifications

Next, modifications of the above embodiments will be described.

The weighing device 1 according to each of the above embodiments may include a windbreak box. The windbreak box accommodates the components of the weighing device 1 according to each of the above embodiments and protects the components from a wind pressure. Accordingly, a decrease in measurement accuracy due to wind is prevented. That is, it is possible to prevent the weight of the object to be measured 9 from being an unintended measurement value due to the wind pressure.

The weighing device 1 according to each of the above embodiments may include an ionizer (static eliminator). The ionizer is disposed in the vicinity of the components of the weighing device 1 according to each of the above embodiments, and eliminates electricity from the components. Accordingly, a decrease in measurement accuracy due to charging is prevented. That is, it is possible to prevent the weight of the object to be measured 9 from being an unintended measurement value due to the charging.

The weighing device 1 according to each of the above embodiments may include a demagnetizer. The demagnetizer is disposed in the vicinity of the components of the weighing device 1 according to each of the above embodiments, and performs demagnetization on the components. Accordingly, a decrease in measurement accuracy due to magnetization of the components is prevented. That is, it is possible to prevent the weight of the object to be measured 9 from being an unintended measurement value due to the magnetization of the components.

The weighing device 1 according to each of the above embodiments may include a medium having a light transmitting property and having a controlled internal air pressure and gas type. Such a medium is disposed on the optical path of the laser beam L. Accordingly, a decrease in measurement accuracy due to changes in environment such as air pressure, temperature, and humidity in a space where the weighing device 1 is placed is prevented. That is, since it is possible to prevent the optical path length from changing due to a change in environment, it is possible to prevent the weight of the object to be measured 9 from being an unintended measurement value. When the internal air pressure is less than the atmospheric pressure, the influence of air resistance on the displacement of the support 2 can be reduced. Further, by controlling the gas type, it is possible to reduce the influence of a mixed gas such as air on the optical path length (the influence of a fluctuation of the optical path length due to a fluctuation of a component of the mixed gas).

Note that, the weighing device 1 according to each of the above embodiments may include at least two of the windbreak box, the ionizer, the demagnetizer, and the medium.

The weighing device 1 according to each of the above embodiments may include a housing and a temperature and humidity adjustment unit. The housing accommodates the components of the weighing device 1 according to each of the above embodiments and isolates an internal space from the outside. The temperature and humidity adjustment unit adjusts a temperature and a humidity of the internal space of the housing. Accordingly, it is possible to prevent the optical path length from being unintentionally changed due to a change in temperature and humidity. When a liquid sample or the like is placed in the internal space of the housing, a drying rate for the liquid sample can be controlled to be constant. Therefore, for example, when a weight of the liquid sample is continuously measured, the influence of drying is easily eliminated, and the measurement accuracy of the weight is easily increased. For example, when counting the number of ink droplets discharged from a head of an inkjet printer, counting accuracy for the number based on the weight measurement result can be improved.

The controller 5 of the weighing device 1 according to each of the above embodiments may have a function of continuously recording or outputting the measurement result such as the weight or the like of the object to be measured 9. Accordingly, for example, when ink droplets are continuously discharged from a head of an inkjet printer, it is possible to continuously record and output a change in pressure during landing, a change in weight during drying, and the like.

In the weighing device 1 according to each of the above embodiments, a plurality of objects to be measured 9 may be simultaneously placed on the placement surface 221. In this case, the controller 5 may have a function of receiving an input of the number of objects to be measured 9 and a function of calculating the weight per object to be measured 9 based on the measurement results of the plurality of objects to be measured 9 and the input number. Accordingly, it is possible to easily measure the weight per object to be measured 9.

### 7. Effects of Embodiments and Modifications

As described above, the weighing device 1 according to each of the embodiments and the modifications includes the support 2, the mirror 3, the laser interferometer 4, and the controller 5. The support 2 has the placement surface 221 on which the object to be measured 9 is to be placed, and the placement surface 221 is displaced according to the mass of the object to be measured 9. The mirror 3 is disposed on the support 2. The laser interferometer 4 detects, using the laser beam L, the change S3 in optical path length to the mirror 3 due to the displacement of the placement surface 221. The controller 5 calculates the weight or the mass of the object to be measured 9 based on the detected change S3 in optical path length. In addition, the laser interferometer 4 includes the laser light source 42 that emits the laser beam L, and the optical modulator 44 that includes the vibrator 442 and that modulates the frequency of the laser beam L using the vibration of the vibrator 442.

According to such a configuration, since the laser interferometer 4 including the optical modulator 44 is provided and the change S3 in optical path length to the mirror 3 due to the displacement of the placement surface 221 can be accurately detected using the laser interference technique, it is possible to implement the weighing device 1 capable of measuring the weight or the mass of the object to be measured 9 with high accuracy while achieving miniaturization.

In the weighing device 1, the support 2 may include the scale pan 22 having the placement surface 221 and the back surface 222 located opposite to the placement surface 221, and the mirror 3 may be disposed on the back surface 222.

According to such a configuration, when the scale pan 22 is displaced downward according to the mass of the object to be measured 9, the back surface 222 and the mirror 3 disposed on the back surface 222 are also displaced downward by the same displacement amount as the placement surface 221, and therefore, when the mirror 3 is disposed on the back surface 222, the weight or the mass of the object to be measured 9 can be accurately measured.

In the weighing device 1, the support 2 may include the elastic body 23. The elastic body 23 may be coupled to the back surface 222 of the scale pan 22 and may elastically deform according to the mass of the object to be measured 9 placed on the placement surface 221.

According to such a configuration, since the elastic body 23 displaces the placement surface 221 by the displacement amount corresponding to the mass of the object to be measured 9, the weight or the like of the object to be measured 9 can be easily measured simply by placing the object to be measured 9 on the placement surface 221 of the scale pan 22.

In the weighing device 1, the elastic body 23 may be coupled to the annular portion of the back surface 222 of the scale pan 22 located outside the mirror 3.

According to such a configuration, when the object to be measured 9 is placed on the placement surface 221, a large change in posture of the scale pan 22 is prevented. That is, the elastic body 23 can elastically deform while the horizontal state of the placement surface 221 is favorably maintained. Accordingly, it is possible to prevent the occurrence of the measurement error due to the unintended inclination of the mirror 3 and instability of the object to be measured 9 due to the unintended inclination of the placement surface 221.

In the weighing device 1, the support 2 may include the scale pan 22 and the optical member 272. The scale pan 22 has the placement surface 221 and the back surface 222 located opposite to the placement surface 221. The optical member 272 is coupled to the back surface 222 of the scale pan 22, and the refractive index changes according to the mass of the object to be measured 9. In addition, the optical member 272 is disposed on the optical path of the laser beam L and has a transmitting property to the laser beam L. Further, the mirror 3 is disposed on the optical member 272.

According to such a configuration, the magnitude of the load due to the mass of the object to be measured 9 can be calculated based on the change S3 in optical path length to the mirror 3, and the weight or the mass of the object to be measured 9 can be calculated.

In the weighing device 1, the mirror 3 may be formed by the interface between the optical member 272 and the back surface 222 of the scale pan 22.

According to such a configuration, since the light reflectivity of the back surface 222 can be used in the mirror 3, a good reflectance can be ensured.

In the weighing device 1, the optical member 272 may be an optical fiber. The mirror 3 may be formed by the interface between the optical fiber and the outside air.

According to such a configuration, the optical member 272 capable of ensuring a long optical path length can be obtained even in a space-saving manner. Accordingly, it is possible to increase the rate of change in optical path length when the optical member 272 receives a load. As a result, the calculation accuracy for the weight or the mass of the object to be measured 9 can be improved.

In the weighing device 1, the support 2 may include the first scale 281, the second scale 282, the scale beam 283, and the fulcrum 284. The first scale 281 has the placement surface 221. The compensation mass for the object to be measured 9 is set in the second scale 282. The scale beam 283 couples the first scale 281 to the second scale 282. The fulcrum 284 supports the scale beam 283 such that the scale beam 283 swings. In addition, the controller 5 sets the compensation mass in the second scale 282. Further, the mirror 3 is disposed on the support 2.

According to such a configuration, the weight or the mass of the object to be measured 9 can be calculated based on the compensation mass when the support 2 is in equilibrium.

In the weighing device 1, the controller 5 may calculate the weight or the mass of the object to be measured 9 based on the detection result of the change S3 in optical path length detected by the laser interferometer 4 and a setting result of the compensation mass.

According to such a configuration, the weight or the mass of the object to be measured 9 can be calculated based on the compensation mass during the equilibrium by the force balance type weighing method.

In the weighing device 1, the controller 5 may temporally change the compensation mass at a constant amplitude. The laser interferometer 4 may detect the amplitude of the change S3 in optical path length to the mirror 3, and the controller 5 may calculate the mass of the object to be measured 9 based on the amplitude of the change S3 in optical path length.

According to such a configuration, the mass of the object to be measured 9 can be directly measured regardless of the gravitational acceleration at the place where the weighing device 1 is installed.

In the weighing device 1, the controller 5 may temporally change the compensation mass, the laser interferometer 4 may detect the change S3 in optical path length to the mirror 3, and the controller 5 may adjust the amplitude of the temporal change in compensation mass such that the amplitude of the detected change S3 in optical path length is constant, and calculate the mass of the object to be measured 9 based on the adjusted amplitude of the temporal change in compensation mass.

According to such a configuration, the mass of the object to be measured 9 can be directly measured regardless of the gravitational acceleration at the place where the weighing device 1 is installed.

In the weighing device 1, the mirror 3 may have retroreflectivity.

According to such a configuration, even when the mirror 3 is inclined, most of the light incident on the mirror 3 can be returned to the laser interferometer 4. Accordingly, it is possible to prevent a decrease in detection accuracy for the change S3 in optical path length detected by the laser interferometer 4. In addition, since the tolerance of the positional deviation of the mirror 3 is increased, it is possible to implement the weighing device 1 having high ease of assembly.

In the weighing device 1, the laser interferometer 4 may further include the beam splitter 46, the photodetector 47, and the processor 48. The beam splitter 46 splits the laser beam L into one and the other. The photodetector 47 receives interference light between one laser beam L subjected to Doppler shift by the mirror 3 and the other laser beam L having passed through the optical modulator 44, and outputs the light receiving signal S1. The processor 48 calculates the change S3 in optical path length to the mirror 3 based on the light receiving signal S1 and the reference signal Ss generated using the vibrator 442 as a signal source.

According to such a configuration, the change S3 in optical path length to the mirror 3 can be detected with very high accuracy by the optical heterodyne method.

Although the weighing device according to the present disclosure is described above based on the shown embodiments, the present disclosure is not limited thereto.

For example, the weighing device according to the present disclosure may be what is obtained by replacing each portion of the embodiments described above with any component having a similar function, or what is obtained by adding any component to the embodiments described above. In addition, the weighing device according to the present disclosure may have a configuration that is a combination of two or more of the embodiments described above.

What is claimed is:

1. A weighing device comprising:
a support having a placement surface on which an object to be measured is to be placed, the placement surface being displaced according to a mass of the object to be measured;
a mirror disposed on the support;
a laser interferometer configured to detect, using a laser beam, a change in optical path length to the mirror due to the displacement of the placement surface; and
a controller configured to calculate a weight or a mass of the object to be measured based on the detected change in optical path length, wherein
the laser interferometer includes a laser light source configured to emit the laser beam, and an optical modulator including a vibrator and configured to modulate a frequency of the laser beam using a vibration of the vibrator.

2. The weighing device according to claim 1, wherein
the support includes a scale pan having the placement surface and a back surface located opposite to the placement surface, and
the mirror is disposed on the back surface.

3. The weighing device according to claim 2, wherein the support includes an elastic body that is coupled to the back surface of the scale pan and that elastically deforms according to the mass of the object to be measured placed on the placement surface.

4. The weighing device according to claim 3, wherein the elastic body is coupled to an annular portion of the back surface located outside the mirror.

5. The weighing device according to claim 1, wherein
the support includes a scale pan having the placement surface and a back surface located opposite to the placement surface, and an optical member coupled to the back surface of the scale pan and having a refractive index that changes according to the mass of the object to be measured,
the optical member that transmits the laser beam is disposed on an optical path of the laser beam, and
the mirror is disposed on the optical member.

6. The weighing device according to claim 5, wherein the mirror is formed by an interface between the optical member and the back surface of the scale pan.

7. The weighing device according to claim 5, wherein
the optical member is an optical fiber, and
the mirror is formed by an interface between the optical fiber and outside air.

8. The weighing device according to claim 1, wherein
the support includes a first scale having the placement surface, a second scale in which a compensation mass for the object to be measured is set, a scale beam configured to couple the first scale to the second scale, and a fulcrum configured to support the scale beam to swing the scale beam,
the controller sets the compensation mass in the second scale, and
the mirror is disposed on the support.

9. The weighing device according to claim 8, wherein the controller calculates the weight or the mass of the object to be measured based on a detection result of the change in optical path length detected by the laser interferometer and the compensation mass.

10. The weighing device according to claim 8, wherein
the controller temporally changes the compensation mass at a constant amplitude,
the laser interferometer detects an amplitude of the change in optical path length, and
the controller calculates the mass of the object to be measured based on the amplitude of the change in optical path length.

11. The weighing device according to claim 8, wherein
the controller temporally changes the compensation mass,
the laser interferometer detects the change in optical path length, and
the controller adjusts an amplitude of a temporal change in compensation mass such that an amplitude of the detected change in optical path length is constant, and calculates the mass of the object to be measured based on the adjusted amplitude of the temporal change in compensation mass.

12. The weighing device according to claim 1, wherein the mirror has retroreflectivity.

13. The weighing device according to claim 1, wherein
the laser interferometer further includes
a beam splitter configured to split the laser beam into one and the other,
a photodetector configured to receive interference light between the one laser beam reflected by the mirror and the other laser beam having passed through the optical modulator and configured to output a light receiving signal, and
a processor configured to calculate the change in optical path length based on the light receiving signal and a reference signal generated by the vibrator as a signal source.
